(19) United States
(12) Patent Application Publication
(10) Pub. No.: US 2024/0219282 A1
(43) Pub. Date: Jul. 4, 2024

(54) APPARATUS AND METHOD FOR DETECTING FINE PARTICLES

(71) Applicant: SAMSUNG ELECTRONICS CO., LTD., Suwon-si (KR)

(72) Inventors: Hyeong Seok JANG, Suwon-si (KR); Won Jong JUNG, Suwon-si (KR); Jin Ha KIM, Suwon-si (KR); Kak NAMKOONG, Suwon-si (KR); Hyung Jun YOUN, Suwon-si (KR); Jae Hong LEE, Suwon-si (KR)

(73) Assignee: SAMSUNG ELECTRONICS CO., LTD., Suwon-si (KR)

(21) Appl. No.: 18/202,794

(22) Filed: May 26, 2023

(30) Foreign Application Priority Data
Jan. 3, 2023 (KR) 10-2023-0000805

(51) Int. Cl. G01N 15/02

(52) U.S. Cl. CPC G01N 15/0205

(57) ABSTRACT

Provided is an apparatus configured to detect fine particles, including a fine particle trap including a plurality of through holes that are configured to trap the fine particles, a measurer including a light source configured to emit light to the plurality of through holes, and a detector configured to detect light scattered, reflected, or transmitted through the plurality of through holes and measure a spectrum, and a processor configured to estimate a number of the fine particles trapped in the plurality of through holes based on of the measured spectrum, wherein the plurality of through holes have a diameter equal to or less than 10 μm.

### CROSS-REFERENCE TO RELATED APPLICATION

This application claims priority to Korean Patent Application No. 10-2023-0000805, filed on Jan. 3, 2023, in the Korean Intellectual Property Office, the entire disclosure of which is incorporated herein by reference.

### BACKGROUND

### 1. Field

Example embodiments of the present disclosure relate to an apparatus and method for detecting fine particles, and more specifically, to an apparatus and method for quantifying fine particles through spectral analysis.

### 2. Description of Related Art

An analysis of samples related to clinics or the environment is achieved through a biochemical, chemical, or mechanical treatment process. Recently, the development of techniques for diagnosing or monitoring a biological sample has drawn a significant interest. The application of a molecular diagnosis method based on nucleic acid has significantly increased recently in the fields of diagnosing an infectious disease or cancer, pharmacogenomics, or developing a new medicine due to its high accuracy and sensitivity. A fine particle device is widely used for simply and precisely analyzing a sample according to various purposes.

### SUMMARY

One or more example embodiments provide an apparatus and method for detecting fine particles, and more specifically, to an apparatus and method for quantifying fine particles through spectral analysis.

According to an aspect of an example embodiment, there is provided an apparatus configured to detect fine particles, including a fine particle trap including a plurality of through holes that are configured to trap the fine particles, a measurer including a light source configured to emit light to the plurality of through holes, and a detector configured to detect light scattered, reflected, or transmitted through the plurality of through holes and measure a spectrum, and a processor configured to estimate a number of the fine particles trapped in the plurality of through holes based on of the measured spectrum, wherein the plurality of through holes have a diameter equal to or less than 10 μm.

The fine particle trap may further include an inlet through which a sample is injected, a channel through which the injected sample moves and an outlet through which the sample is discharged, and the plurality of through holes may be formed to penetrate in a direction perpendicular to a length direction of the channel such that the sample moving along the channel is trapped.

The fine particles may be trapped in the through holes by at least one of capillarity, dielectrophoresis, or photothermal effect.

The fine particle trap may further include an alternating current (AC) electrode configured to induce the dielectrophoresis based on a control of the processor.

The fine particle trap may further include a heat source configured to generate the photothermal effect based on a control of the processor.

The plurality of through holes may be provided to have photonic crystals.

A shape of each of the plurality of through holes and a size of each of the plurality of through holes may be determined based on at least one of a shape of each target fine particles, a size of each target fine particles, or a type of each target fine particles.

The processor may be further configured to extract one or more features from the spectrum and estimate the number of the fine particles based on the extracted features using a fine particle estimation model.

The processor may be further configured to extract the one or more features from the spectrum using a principal component analysis (PCA).

The one or more features may include a feature of at least one of a first principal component extracted from the spectrum through the PCA and a second principal component extracted from the spectrum through the PCA.

The processor may be further configured to determine whether to perform calibration and, based on determining to perform calibration, calibrate the fine particle estimation model using one or more reference particles.

Based on the one or more reference particles being trapped in the plurality of through holes, the processor may be further configured to control the measurer to obtain a plurality of calibration spectra and train the fine particle estimation model based on the obtained plurality of calibration spectra.

According to another aspect of an example embodiment, there is provided a method of detecting fine particles, including trapping the fine particles in a plurality of through holes, emitting, by a light source, light to the plurality of through holes, detecting, by a detector, light scattered, reflected, or transmitted through the plurality of through holes, measuring, by the detector, a spectrum based on the detected light, and estimating, by a processor, a number of the fine particles trapped in the plurality of through holes based on the measured spectrum, wherein the plurality of through holes have a diameter equal to or less than 10 μm.

The fine particles may be trapped in the through holes by at least one of capillarity, dielectrophoresis, or photothermal effect.

The method may further include controlling, by the processor, an alternating current (AC) voltage of a fine particle trap to induce the dielectrophoresis.

The method may further include controlling, by the processor, a heat source included in a fine particle trap to generate the photothermal effect.

The estimating of the number of the fine particles may include extracting one or more features from the spectrum and estimating the number of the fine particles based on the extracted features using a fine particle estimation model.

The extracting of the one or more features may include extracting the one or more features from the spectrum using a principal component analysis (PCA).

The method may further include determining whether to perform calibration, and calibrating the fine particle estimation model using one or more reference particles based on determining to perform calibration.

The calibrating of the fine particle estimation model may include trapping the one or more reference particles in the plurality of through holes, obtaining a plurality of calibration spectra, and training the fine particle estimation model based on the obtained plurality of calibration spectra.

### BRIEF DESCRIPTION OF THE DRAWINGS

Embodiments will be more clearly understood from the following detailed description taken in conjunction with the accompanying drawings in which:

FIG. 1 is a block diagram illustrating an apparatus configured to detect fine particles according to an example embodiment;

FIGS. 2A, 2B, 2C, and 2D are structural diagrams of a fine particle trap according to example embodiments;

FIGS. 3A, 3B, 3C, and 3D are diagrams illustrating examples of quantifying fine particles through spectrum analysis;

FIG. 4 is a block diagram illustrating an apparatus configured to detect fine particles according to another example embodiment;

FIG. 5 is a flowchart illustrating a method of detecting fine particles according to an example embodiment; and

FIG. 6 is a flowchart illustrating a method of detecting fine particles according to another example embodiment.

### DETAILED DESCRIPTION

Details of example embodiments are included in the following detailed description and drawings. Advantages and features of the disclosure, and a method of achieving the same will be more clearly understood from the following embodiments described in detail with reference to the accompanying drawings. Throughout the drawings and the detailed description, unless otherwise described, the same drawing reference numerals will be understood to refer to the same elements, features, and structures.

It will be understood that, although the terms first, second, etc. may be used herein to describe various elements, these elements should not be limited by these terms. These terms are only used to distinguish one element from another. Also, the singular forms are intended to include the plural forms as well, unless the context clearly indicates otherwise. It will be further understood that when an element is referred to as “comprising” another element, the element is intended not to exclude one or more other elements, but to further include one or more other elements, unless explicitly described to the contrary. In the following description, terms such as “unit” and “module” indicate a unit for processing at least one function or operation and they may be implemented by using hardware, software, or a combination thereof.

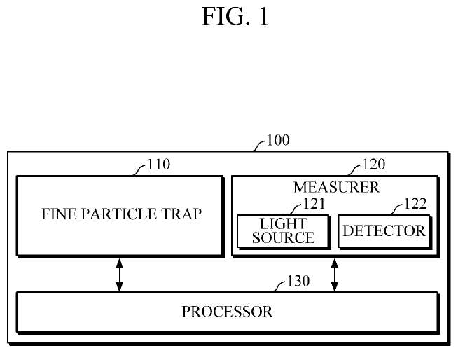

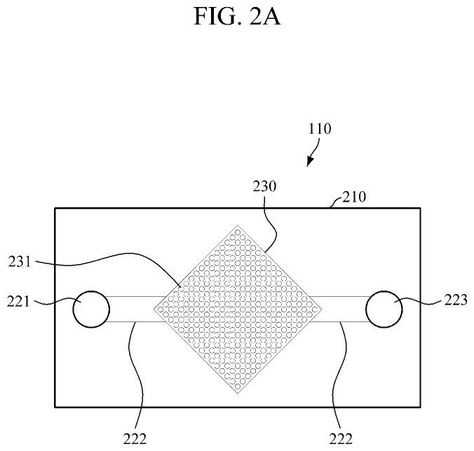

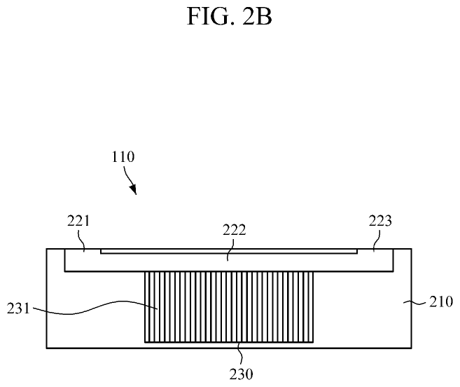

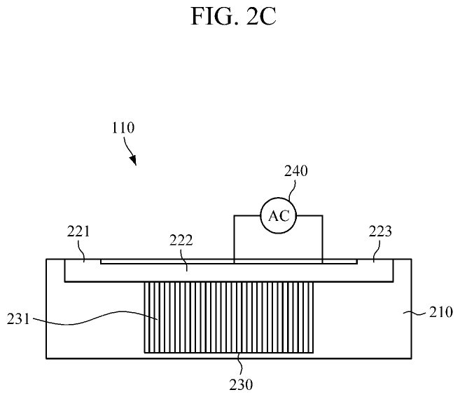

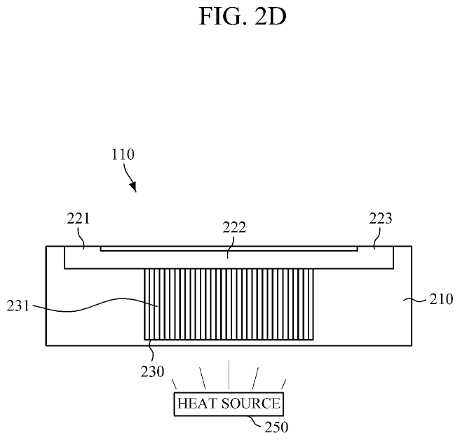

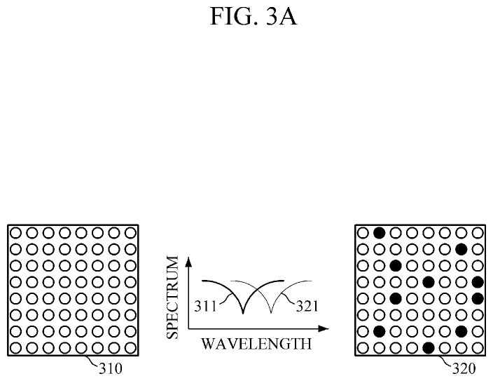

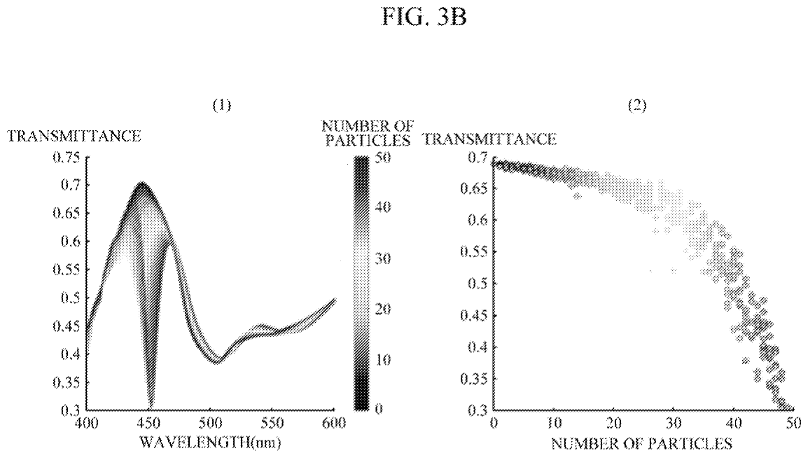

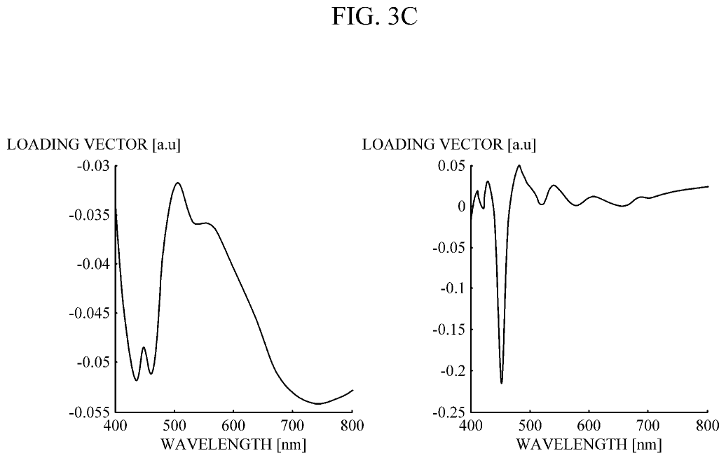

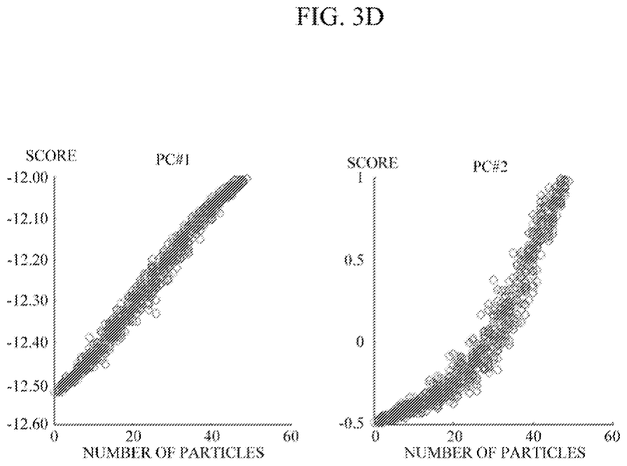

FIG. 1 is a block diagram illustrating an apparatus configured to detect fine particles according to an example embodiment. FIGS. 2A to 2D are structural diagrams of a fine particle trap according to example embodiments. FIGS. 3A to 3D are diagrams illustrating examples of quantifying fine particles through spectrum analysis.

Referring to FIG. 1, an apparatus 100 configured to detect fine particles includes a fine particle trap 110, a measurer 120, and a processor 130.

When a sample is injected, the fine particle trap 110 may trap target fine particles. The sample may include respiratory secretions, or bio-fluids including at least one of blood, urine, perspiration, tears, saliva, etc., or a swab sample of an upper respiratory tract, dust in the atmosphere, or a solution of the bio-fluid, the dust, or the swab sample dispersed in other medium. In this case, the other medium may include water, saline solution, alcohol, phosphate buffered saline solution, vital transport media, etc., but is not limited thereto. The target fine particles may include ribonucleic acid (RNA), deoxyribonucleic acid (DNA), peptide nucleic acid (PNA), locked nucleic acid (LNA), virus (e.g., RNA virus, DNA virus, PNA virus, LNA virus), or duplex of one or two or more types of LNA virus, bacteria, pathogens, germs, oligopeptides, proteins, toxin, particulate matter, etc., but are not limited thereto. The term “particulate matter” may refer to tiny particles suspended in the air that can be inhaled into lungs and cause various health problems.

FIG. 2A is a plan view illustrating a structure of the fine particle trap 110. FIGS. 2B to 2D are front views of the structure of the fine particle trap 110.

The fine particle trap 110 may include an inlet 221 through which a sample is injected into a substrate 210, a channel 222 through which the injected sample moves, and an outlet 223 through which the sample is discharged. The fine particle trap may further include a chamber 230 in which fine particles included in the sample are trapped when the sample moves along the channel 222.

The substrate 210 may be formed of an inorganic material, such as silicon (Si), glass, polymer, metal, ceramic, graphite, etc., or a material such as acrylic-based material, polyethylene terephtalate (PET), polycarbonate, polystylene, polypropylene, silicon nitride (SixNy), titanium oxide (TiO2), silicon oxide (SiO2), etc. The substrate 210 may include a function layer configured to adjust optical characteristics. For example, the substrate 210 may be treated with gold (Au), or anti-reflection coating, hydrophilic/hydrophobic coating, antigen-antibody treatment, or aptamer treatment may be performed on the substrate 210.

The substrate 210 may have a predetermined thickness. The thickness of the substrate 210 may vary without limitation in consideration of the type and size of the target fine particles and thermal conductivity used for each layer of the substrate 210. The term “fine particle” may refer to a particle having a size of 100 μm or less in diameter. The substrate 210 may be formed of multiple layers. For example, the substrate 210 may include a first layer in which the inlet 221, the channel 222, and the outlet 223 are formed and a second layer in which the chamber 230 is formed. A third layer may be formed below the second layer. The layers may be integrally formed of the same material, or may be separately formed of the same material or different materials and bonded to one another. For example, each layer may be formed of a material having a different thermal conductivity. For example, the first to third layers may be formed of a material that has thermal conductivity increasing stepwise from in the first layer to in the third layer. According to another example embodiment, the second layer and the third layer may be formed of a material having the same thermal conductivity that is greater than a thermal conductivity of the first layer.

The inlet 221 and the outlet 223 may be formed to communicate with the channel 222. The cross-sectional diameter of the inlet 221 connected to the channel 222 may be equal to or smaller than the cross-sectional diameter of the channel 222, but embodiments are not limited thereto. The inlet 221 may be irregularly formed such that its cross-section gradually increases or decreases toward the channel 222, but embodiments are not limited thereto. The cross-section of the inlet 221 may have various shapes, such as, for example, a circular shape, an elliptical shape, a hexagonal shape, a triangular shape, and the like. The outlet 223 may include an absorbent pad that may move and drain a solution using capillarity. In this way, a movement speed of the solution may be more easily controlled.

A filter may be further disposed in the channel 222 at a position in front and/or at the rear of the chamber 230 to pass particles having a predetermined size or less. The filter may include, for example, silicon, polyvinylidene fluoride (PVDF), polyethersulfone, polycarbonate, glass fiber, polypropylene, cellulose, mixed cellulose esters, polytetrafluoroethylene (PTFE), polyethylene terephthalate, polyvinyl chloride (PVC), nylon, phosphocellulose, diethylaminoethyl cellulose (DEAE), and the like, but embodiments are not limited thereto. Holes may have various shapes, such as, for example, a circular shape, a square shape, a slit shape, an irregular shape by glass fiber, and the like.

The chamber 230 may include a plurality of through holes 231. Tens of or more through holes 231 may be provided. Each through hole 231 may have a diameter that is equal to or less than 10 μm to trap fine particles one-by-one. The through holes 231 may be formed to penetrate in a direction perpendicular to the length direction of the channel 222, that is, in a direction from the first layer to the second layer of the substrate 210, as shown in FIG. 2B. The through holes 231 may have a constant cross-section. The cross-section of the through hole 231 may have various shapes, such as, for example a hexagonal shape, a rectangular shape, a triangular shape, a circular shape, and the like. For example the through hole 231 may be formed as a hexagonal cavity, a rectangular cavity, a circular cavity, a circular cavity, or the like.

The plurality of through holes 231 may be grouped into two or more through hole groups having different shapes or sizes to trap two or more types of fine particles having different sizes or shapes. In this case, the through hole groups may be arranged in the order of size so that gradually larger particles can be trapped along the movement direction of the sample. The number and arrangement of the through holes and the size and shape of each through hole are not limited, and may vary depending on the shape, size, type, and the like of the target fine particles.

When the sample injected through the inlet 221 moves along the channel 222, the fine particles included in the sample may be trapped in the through holes 231 by capillarity. The plurality of through holes 231 may be arranged in an N×M multi-dimensional array. In this case, N and M are integers greater than or equal to 2, which may be the same or different numbers. By using the multi-dimensional array, the fine particles of the sample may be trapped into the through holes 231 by capillarity at a higher speed. The through holes 231 may be arranged to have photonic crystals by adjusting the arrangement spacing of all or some of the plurality of through holes 231.

Referring to FIG. 2C, the fine particle trap 110 may further include an alternating current (AC) electrode 240. The AC electrode 240 may be disposed inside or outside of the channel 222, or may be disposed on an outer surface of the channel 222 in an array form. According to another example embodiment, the AC electrode 240 may be disposed on an inner surface or outer surface of the through hole 231. The AC electrode 240 may apply an AC voltage to the fine particle trap 110 under the control of the processor 130, and allow the fine particles in the sample to be trapped in the through holes 231 by dielectrophoresis induced through the applied AC voltage.

Referring to FIG. 2D, the fine particle trap 110 may further include a heat source 250. The heat source 250 may be a light source configured to emit light to the plurality of through holes 231 of the chamber 230. The light source may emit laser light. However, embodiments are not limited thereto. Light emitted by the light source may be converted into heat to induce a photothermal effect, and the fine particles in the sample may be quickly trapped in the plurality of through holes 231 by the photothermal effect. The heat source 250 may be formed as an electrical heating element.

A photothermal film configured to convert light into heat may be attached to the interior of the chamber 230, the interior of the substrate 210, or the entire or part of the bottom surface of the substrate 210. The thickness of the photothermal film is not particularly limited, and may be appropriately modified in consideration of characteristics of a material used as the photothermal film, such as thermal conductivity or heat retention. The photothermal film may be formed of a material, such as polymer, metal, metal oxide, nanocomposite, nanostructure, semiconductor, or the like. For example, a polyimide (PI) film, a gold (Au) film, or an aluminum nanostructure (AlNS) film may be used.

The fine particle trap 110 may further include a temperature sensor. The temperature sensor may measure a temperature of through holes 231 heated by the heat source 250 and send the measured temperature to the processor 130. The processor 130 may control the heat source 250 based on the measured temperature so that the plurality of through holes 231 maintain a constant temperature.

The fine particle trap 110 may include both the electrode 240 and the heat source 250. The processor 130 may selectively or simultaneously control the electrode 240 and the heat source 250 so that the fine particles can be more effectively trapped in the plurality of through holes by capillarity, dielectrophoresis, and photothermal effect. However, embodiments are not limited thereto, and the fine particle trap 110 may further include an active and/or passive driving device, such as a passive vacuum void pump, a syringe pump, a vacuum pump, a pneumatic pump, and the like, and/or a structure used for moving the solution, such as an electro-wetting device.

Referring back to FIG. 1, the measurer 120 may include a light source 121 and a detector 122. When the fine particles are trapped in the plurality of through holes 231, a transmission, scattering, or reflection spectrum may be measured from the plurality of through holes 231 by using the light source 121 and the detector 122.

The light source 121 may be one of, for example, a light emitting diode (LED), a vertical-cavity surface-emitting laser (VCSEL), a laser diode (LD), a tungsten lamp, a fluorescent lamp, a halogen lamp, a mercury lamp, a xenon lamp, a metal halide lamp, or a combination thereof. A wavelength band of the light emitted by the light source 121 is nor particularly limited.

The detector 122 may detect light scattered, reflected, or transmitted through the plurality of through holes. The detector 122 may include, for example, a photomultiplier tube, a photo detector, a photomultiplier tube array, a photo detector array, a complementary metal-oxide semiconductor (CMOS) sensor, or a spectrometer.

The light source 121 and the detector 122 may be disposed in opposite directions relative to each other with respect to the plurality of through holes. In this way, when the light emitted to the plurality of through holes 231 by the light source 121 passes through the plurality of through holes 231, the measurer 120 may use the detector 122 to detect the light that has passed through the holes and obtain a transmission spectrum based on the detected light. However, the arrangement structure is not limited those illustrated in the drawings, and may be variously modified in consideration of the type and size of the fine particles, structural limitations of the device 100, and the like. When the light source 121 is arranged in the same direction as the heat source 250 of the fine particle trap 110, the light source 121 and the heat source 250 may be unitarily formed, or a part of the light source 121 may be used as the heat source 250.

The processor 130 may control the fine particle trap 110 and the measurer 120, and estimate the number of fine particles trapped in the plurality of through holes 231 based on the spectrum measured by the measurer 120.

For example, the processor 130 may control the electrode 240 and/or the heat source 250 such that the fine particles in the sample can be more rapidly trapped in the plurality of through holes by the capillarity, dielectrophoresis, and/or photothermal effect when the sample injected into the inlet 221 of the fine particle trap 110 moves along the channel 222. In this case, control conditions for the electrode 240 and/or the heat source 250 may be predefined. In addition, the processor 130 may obtain a spectrum by repeatedly controlling the light source 121 and the detector 122 included in the measurer 120 one or more times when the fine particles are trapped in the plurality of through holes. The driving conditions (e.g., wavelength, intensity of current, duration, etc.) for the light source 121 may be predefined, and the processor 130 may drive the light source according to the driving conditions.

When one or more spectra are measured, the processor 130 may estimate the number of fine particles trapped in the plurality of through holes by analyzing the measured spectra. The processor 130 may extract one or more features by analyzing the spectra, and estimate the number of fine particles by applying a predefined fine particle estimation model to the extracted features. Here, the estimation model, which is a model that defines a correlation between features extracted from a spectrum and the number of fine particles, may be a linear model, a regression model, a neural network model, etc. However, embodiments are not limited thereto.

FIG. 3A is a diagram illustrating a change in transmission spectra before and after fine particles are trapped in the plurality of through holes. The left side of FIG. 3A shows through holes 310 before fine particles are trapped, and the right side shows through holes 320 after the fine particles are trapped. A spectrum 311 represents a transmission spectrum as measured in the through holes 310 before fine particles are trapped and a spectrum 321 represents a transmission spectrum as measured in the through holes 320 after the fine particles are trapped.

FIG. 3B illustrates a transmission spectrum 1 measured in the plurality of through holes and a graph 2 showing the change trend of transmittance according to the number of fine particles trapped in the plurality of through holes. As the fine particles are trapped in the through holes, the transmission spectrum changes and the change in transmission spectrum has a correlation with the number of the trapped fine particles. Based on this correlation, the number of the fine particles trapped in the plurality of through holes may be estimated.

The processor 130 may extract one or more features from the transmission spectrum measured in the plurality of through holes. For example, the processor 130 may extract one or more principal components as features by performing a principal component analysis (PCA) on the transmission spectrum. For example, the processor 130 may extract one of the first principal component and the second principal component as a feature, or extract a value obtained by combining the two principal components as a feature. However, embodiments are not limited thereto, and the feature may be extracted by using at least one of the transmission spectrum 311 before the fine particles are trapped and the transmission spectrum 321 after the fine particles are trapped. For example, a difference of the lowest point between spectrum 311 and spectrum 321, a difference of the peak point between spectrum 311 and spectrum 321, or a wavelength difference between valley points between spectrum 311 and spectrum 321 may be extracted as a feature.

The processor 130 may input the extracted feature into the fine particle estimation model and estimate an output value of the model as the number of fine particles. FIG. 3C shows graphs of the first principal component PC #1 and the second principal component PC #2 extracted from the transmission spectrum, and FIG. 3D shows graphs illustrating a correlation between the score of each of the principal components PC #1 and PC #2 and the number of fine particles. The fine particle estimation model may be model that defines a correlation between a principal component (e.g., PC #2) extracted from a transmission spectrum and the number of fine particles. Through the fine particle estimation model, the number of the fine particles trapped in the plurality of through holes may be directly quantified, thereby minimizing quantitative errors even when the chamber size is small.

The processor 130 may determine whether to calibrate the fine particle estimation model, and perform calibration of the fine particle estimation model when it is determined to perform calibration. In this case, conditions for performing calibration may be predefined. According to the conditions for performing calibration, calibration may be performed when there is a user's request, when a preset calibration period is reached, or before or after the fine particles are estimated. Upon determining to perform calibration, the processor 130 may guide the user to perform calibration, thereby preparing reference particles or the like.

When it is determined to perform calibration, reference particles may be injected through the inlet 221. The reference particles may include one or more types of fine particles and a predefined number of fine particles of each type. When the reference particles are injected to the inlet 221, the processor 130 may control the electrode 240 and/or the heat source 250 of the fine particle trap 110 so that the reference particles can be trapped in the plurality of through holes 231 of the chamber 230. When the reference particles are trapped in the plurality of through holes 231, the processor 130 may control the measurer 120 several times to obtain a plurality of calibration spectra in the plurality of through holes 231. When the calibration spectra are obtained, one or more features may be extracted as training data from the obtained calibration spectra, and the fine particle estimation model may be trained using the extracted training data. For example, a principal component (e.g., the first or second principal component) may be extracted as training data by performing a PCA of the calibration spectra, and the fine particle estimation model that defines a correlation between the principal component and the number of fine particles may be trained based on the extracted training data.

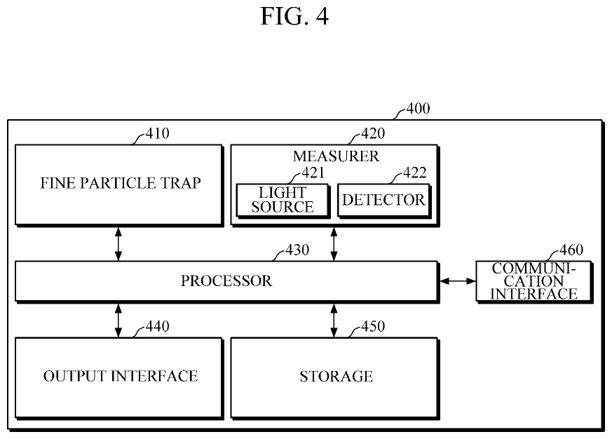

FIG. 4 is a block diagram illustrating an apparatus configured to detect fine particles according to another example embodiment.

Referring to FIG. 4, an apparatus 400 configured to detect fine particles may include a fine particle trap 410, a measurer 420, a processor 430, an output interface 440, a storage 450, and a communication interface 460. The measurer 420 includes a light source 421 and a detector 422, and the fine particle trap 410, the measurer 420, and the processor 430 are described above, and thus detailed descriptions thereof will not be reiterated below.

The output interface 440 may output the processing process or processing results (e.g., the estimated number of fine particles) of the fine particle trap 410, the measurer 420, and the processor 430. The output interface 440 may provide information to the user using, for example, a visual output module (e.g., display), a voice output module (e.g., speaker), a haptic module, and the like. In addition, the output interface 440 may output calibration guide under the control of the processor 430.

The storage 450 may store various types of data (e.g., calibration conditions, light source control conditions, heat source control conditions, electrode control conditions, a fine particle estimation model, etc.) necessary for the fine particle trap 410, the measurer 420, and the processor 430 and/or processing results (e.g., the number of fine particles). The storage 450 may include at least one type of storage medium of a flash memory type, a hard disk type, a multimedia card fine type, a card type memory (for example, secure digital (SD) or extreme digital (XD) memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The communication interface 460 may communicate with an external device to transmit and receive various data to and from the external device under the control of the processor 430. The external device may be medical equipment, a printer to print out results, a display to display the results, a digital television (TV), a desktop computer, a cellular phone, a smartphone, a tablet device, a laptop computer, a personal digital assistant (PDA), a portable multimedia player (PMP), a navigation system, an MP3 player, a digital camera, a wearable device, and the like, but is not limited thereto.

The communication interface 460 may communicate with the external device by using various communication techniques such as Bluetooth communication, Bluetooth Low Energy (BLE) communication, Near Field Communication (NFC), WLAN communication, Zigbee communication, Infrared Data Association (IrDA) communication, wireless fidelity (Wi-Fi) Direct (WFD) communication, Ultra-Wideband (UWB) communication, Ant+ communication, Wi-Fi communication, Radio Frequency Identification (RFID) communication, 3G communication, 4G communication, 5G communication, and the like. However, embodiments are not limited thereto.

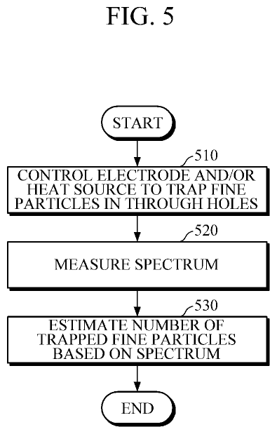

FIG. 5 is a flowchart illustrating a method of detecting fine particles according to an example embodiment.

The method illustrated in FIG. 5 is an example of a method of detecting fine particles performed by the apparatuses 100 and 400 configured to detect fine particles shown in FIGS. 1 and 4, which is described in detail above, and will be briefly described below.

In operation 510, when a sample is injected into the inlet of the fine particle trap, the electrode and/or the heat source may be controlled to allow fine particles to be trapped in a plurality of through holes. The plurality of through holes may have a diameter of 10 μm or less to trap the fine particles, for example, super-fine particles one-by-one, and the number and arrangement of the through holes and the size and shape of each through hole are not particularly limited and may vary depending on the shape, size, and type of target fine particles. The plurality of through holes are formed to penetrate in a direction perpendicular to the length direction of the channel so that the fine particles in the sample moving along the channel can be more rapidly trapped in the through holes by capillarity, dielectrophoresis, and/or photothermal effect.

In operation 520, a spectrum may be obtained from the plurality of through holes by the measurer. The light source included in the measurer may be controlled to emit light to the plurality of through holes in which the fine particles are trapped, and light scattered, reflected, or transmitted through the plurality of through holes may be detected by the detector to obtain the spectrum.

In operation 530, the number of the fine particles trapped in the through holes may be estimated by analyzing the measured spectrum. For example, a feature may be extracted from the spectrum by analyzing the spectrum through a PCA. In this case, the feature may be the first principal component and/or the second principal component of the spectrum.

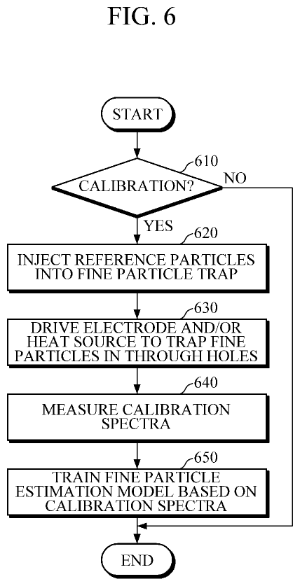

FIG. 6 is a flowchart illustrating a method of detecting fine particles according to another example embodiment.

The method illustrated in FIG. 5 is an example of a method of detecting fine particles performed by the apparatuses 100 and 400 configured to detect fine particles shown in FIGS. 1 and 4, which is described in detail above, and will be briefly described below.

In operation 610, the processor may determine whether to calibrate the fine particle estimation model. The processor may determine to calibrate the fine particle estimation model when a predetermined condition is satisfied. According to the conditions for performing calibration, calibration may be performed when there is a user's request, when a preset calibration period is reached, or before or after the fine particles are estimated.

In operation 620, reference particles may be injected into the inlet of the fine particle trap. Here, the reference particles may include a preset type and preset number of fine particles, and there may be one or more types of the reference particles.

Then, the reference particles injected into the inlet of the fine particle trap move along the channel and are trapped in the plurality of through holes by capillarity, dielectrophoresis, and/or photothermal effect. In this case, the processor may control the electrode and/or the heat source to induce the dielectrophoresis and/or photothermal effect.

In operation 630, a plurality of calibration spectra may be measured through the light source and detector included in the measurer.

In operation 640, the fine particle estimation model may be trained based on the plurality of calibration spectra. For example, a plurality of principal components may be extracted as training data by performing a PCA of the plurality of calibration spectra, and the fine particle estimation model may be trained based on the extracted training data.

The present disclosure may be realized as a computer-readable code written on a computer-readable recording medium. The computer-readable recording medium may be any type of recording device in which data is stored in a computer-readable manner.

Examples of the computer-readable recording medium include a read-only memory (ROM), a random-access memory (RAM), a compact disc (CD)-ROM, a magnetic tape, a floppy disc, an optical data storage, and a carrier wave (e.g., data transmission through the Internet). The computer-readable recording medium may be distributed over a plurality of computer systems connected to a network so that a computer-readable code is written thereto and executed therefrom in a decentralized manner. Functional programs, codes, and code segments for implementing the disclosure be easily deduced by computer programmers of ordinary skill in the art, to which the disclosure pertains.

While example embodiments have been described with reference to the figures, it will be understood by those of ordinary skill in the art that various changes in form and details may be made therein without departing from the spirit and scope as defined by the following claims and their equivalents.

What is claimed is:

1. An apparatus configured to detect fine particles, comprising:
a fine particle trap comprising a plurality of through holes that are configured to trap the fine particles;
a measurer comprising:
a light source configured to emit light to the plurality of through holes; and
a detector configured to detect light scattered, reflected, or transmitted through the plurality of through holes and measure a spectrum; and
a processor configured to estimate a number of the fine particles trapped in the plurality of through holes based on of the measured spectrum,
wherein the plurality of through holes have a diameter equal to or less than 10 μm.

2. The apparatus of claim 1, wherein the fine particle trap further comprises an inlet through which a sample is injected, a channel through which the injected sample moves and an outlet through which the sample is discharged, and
wherein the plurality of through holes are formed to penetrate in a direction perpendicular to a length direction of the channel such that the sample moving along the channel is trapped.

3. The apparatus of claim 1, wherein the fine particles are trapped in the through holes by at least one of capillarity, dielectrophoresis, or photothermal effect.

4. The apparatus of claim 3, wherein the fine particle trap further comprises an alternating current (AC) electrode configured to induce the dielectrophoresis based on a control of the processor.

5. The apparatus of claim 3, wherein the fine particle trap further comprises a heat source configured to generate the photothermal effect based on a control of the processor.

6. The apparatus of claim 1, wherein the plurality of through holes are provided to have photonic crystals.

7. The apparatus of claim 1, wherein a shape of each of the plurality of through holes and a size of each of the plurality of through holes are determined based on at least one of a shape of each target fine particles, a size of each target fine particles, or a type of each target fine particles.

8. The apparatus of claim 1, wherein the processor is further configured to extract one or more features from the spectrum and estimate the number of the fine particles based on the extracted features using a fine particle estimation model.

9. The apparatus of claim 8, wherein the processor is further configured to extract the one or more features from the spectrum using a principal component analysis (PCA).

10. The apparatus of claim 9, wherein the one or more features comprise a feature of at least one of a first principal component extracted from the spectrum through the PCA and a second principal component extracted from the spectrum through the PCA.

11. The apparatus of claim 8, wherein the processor is further configured to determine whether to perform calibration and, based on determining to perform calibration, calibrate the fine particle estimation model using one or more reference particles.

12. The apparatus of claim 11, wherein, based on the one or more reference particles being trapped in the plurality of through holes, the processor is further configured to control the measurer to obtain a plurality of calibration spectra and train the fine particle estimation model based on the obtained plurality of calibration spectra.

13. A method of detecting fine particles, comprising:
trapping the fine particles in a plurality of through holes;
emitting, by a light source, light to the plurality of through holes;
detecting, by a detector, light scattered, reflected, or transmitted through the plurality of through holes;
measuring, by the detector, a spectrum based on the detected light; and
estimating, by a processor, a number of the fine particles trapped in the plurality of through holes based on the measured spectrum,
wherein the plurality of through holes have a diameter equal to or less than 10 μm.

14. The method of claim 13, wherein the fine particles are trapped in the through holes by at least one of capillarity, dielectrophoresis, or photothermal effect.

15. The method of claim 14, further comprising:
controlling, by the processor, an alternating current (AC) voltage of a fine particle trap to induce the dielectrophoresis.

16. The method of claim 14, further comprising:
controlling, by the processor, a heat source included in a fine particle trap to generate the photothermal effect.

17. The method of claim 13, wherein the estimating of the number of the fine particles comprises extracting one or more features from the spectrum and estimating the number of the fine particles based on the extracted features using a fine particle estimation model.

18. The method of claim 17, wherein the extracting of the one or more features comprises extracting the one or more features from the spectrum using a principal component analysis (PCA).

19. The method of claim 17, further comprising:
determining whether to perform calibration; and
calibrating the fine particle estimation model using one or more reference particles based on determining to perform calibration.

20. The method of claim 19, wherein the calibrating of the fine particle estimation model comprises:
trapping the one or more reference particles in the plurality of through holes;
obtaining a plurality of calibration spectra; and
training the fine particle estimation model based on the obtained plurality of calibration spectra.
